(19) United States
(12) Patent Application Publication
(10) Pub. No.: US 2010/0153741 A1
(43) Pub. Date: Jun. 17, 2010

(54) ENCRYPTING SYSTEM AND METHOD FOR NUMERICAL CONTROL DEVICES

(75) Inventor: SHOU-MING LIANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/353,933

(22) Filed: Jan. 14, 2009

(30) Foreign Application Priority Data
Dec. 16, 2008 (CN) 200810306297.9

(51) Int. Cl. H04L 9/06; G05B 19/18

(52) U.S. Cl. 713/189; 700/79

(57) ABSTRACT

An encrypting system for numerical control devices includes a function module, a code module, a memory, and a controller. The function module includes function programs. Each of the function programs presetting a service life. The code module encrypts and decrypts the service life of each of the function programs. The memory stores the service life encrypted by the code module. The controller reads the encrypted service life from the memory according to an input instruction and controlling the code module to decrypt the encrypted service life, and comparing the decrypted service life with the current date to control the function program to be executed in response to the service life of the function program being valid.

### BACKGROUND

1. Technical Field

The present disclosure relates to encrypting systems and encrypting methods and, particularly, to an encrypting system and an encrypting method for computerized numerical control (CNC) devices.

2. Description of Related Art

With development of automation, CNC devices are used widely. In a CNC machine, a plurality of function programs corresponding to different processes is stored in a controller. A soft key is corresponding to one of the plurality of function programs. When an article is to be processed, a corresponding function program is selected via a corresponding soft key. Sometimes, the function programs need to have a test run before official sales, however, the programs could be pirated during test run period, which would result in loss of revenue for the makers of the function programs.

### BRIEF DESCRIPTION OF THE DRAWINGS

FIG. 1 is a block diagram of an embodiment of an encrypting system of computerized numerical control (CNC) devices.

FIG. 2 is a flowchart of an embodiment of an encrypting method of computerized numerical control (CNC) devices.

### DETAILED DESCRIPTION

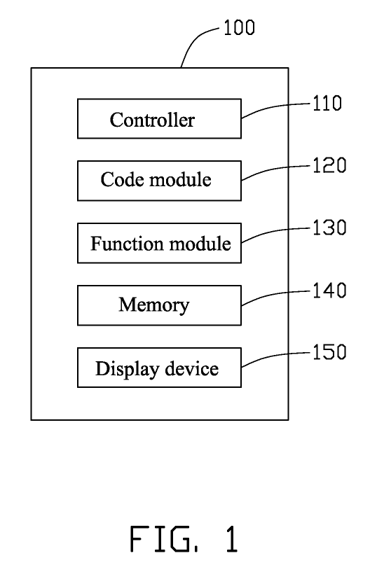

Referring to FIG. 1, an exemplary embodiment of an encrypting system 100 for a computerized numerical control (CNC) device includes a controller 110, a code module 120, a function module 130, a memory 140, and a display device 150. The function module 130 includes a plurality of function programs 1, 2 . . . N. Each of the function programs presets a service state and a service life. The service state includes states of “open” and “close.” The open state presents that the function program can be executed, while the close state presents that the function program cannot be executed. The service life can be configured according to need. Referring to Table 1, the service life of the function program 1 is to expire on Dec. 31, 2008, the service life of the function program 2 is to expire on Dec. 10, 2008, and the service life of the function program 3 is to expire on Jan. 30, 2009.

TABLE 1

| Function program | Service state | Service life |
|---|---|---|
| 1 | open/close | Dec. 31, 2008 |
| 2 | open/close | Dec. 10, 2008 |
| . . . | . . . | . . . |
| N | open/close | Jan. 30, 2009 |

When the service life of a function program is later than the current date, at the same time, the service state of the function program is at open state, the function program can be executed. In one embodiment, the code module 120 encrypts and decrypts the service life of the plurality of function programs by Rijindael algorithm. The memory 140 is an electrically erasable programmable read only memory (EEPROM).

The function module 130 is configured for executing movements according to control signals from the controller 110. The memory 140 is configured for storing the service life encrypted via the code module 120. The display device 150 is configured for displaying the service life decrypted by the code module 120. The controller 110 is configured for controlling the code module 120 to encrypt the service lives of the plurality of function programs according to an input instruction from a user, and controlling the memory 140 to store the encrypted service lives of the plurality of function programs.

Before use, the service life of each of the plurality of function programs in the CNC device are preset, and input instructions are provided to the controller 110. The controller 110 controls the code module 120 to encrypt the service lives of the plurality of function programs according to the input instructions, and controls the memory 140 to store the encrypted service life. In use, when a function program of the CNC device is needed, a corresponding input instruction is provided to the controller 110 for signaling the controller 110 to read the corresponding encrypted service life from the memory 140 and controlling the code module 120 to decrypt the read encrypted service life, and comparing the decrypted service life with the current date. If the service life of the function program is earlier the current date, the controller 110 controls the display device 150 to display “the service life expiration,” or similar messages. The function program does not get executed. If the service life of the function program is later than the current date, the controller 110 controls the display device 150 to display the decrypted service life, and executes the function program according to the service state of the function program.

For example, if the current date is Nov. 20, 2008. The function program 1 is a speedup function of the CNC device. The service life of the function program 1 is to expire on Dec. 31, 2008. The service life of the function program 1 is encrypted via the code module 120 and stored in the memory 140. When the function program 1 is needed, a corresponding input instruction is provided to the controller 110. The controller 110 reads the encrypted service life of the function program 1 from the memory 140 and controls the code module 120 to decrypt the encrypted service life of the function program 1, to get the service life of the function program 1, i.e., Dec. 31, 2008. The service life of the function program 1 is later than the current date. If the controller 110 controls the service state of the function program 1 to be open, the function program 1 can be executed. If the controller 110 controls the service state of the function program 1 to be close, the function program 1 does not get executed.

The function program 2 is, for example, a speed-down function of the CNC device. The service life of the function program 2 is to expire on Nov. 10, 2008. The service life of the function program 2 is encrypted via the code module 120 and stored in the memory 140. When the function program 2 is needed, a corresponding input instruction is provided to the controller 110. The controller 110 reads the encrypted service life of the function program 2 from the memory 140 and controls the code module 120 to decrypt the encrypted service life of the function program 2, to get the service life of the function program 2, i.e., Nov. 10, 2008. The service life of the function program 2 is earlier than the current date, the function program 2 does not get executed.

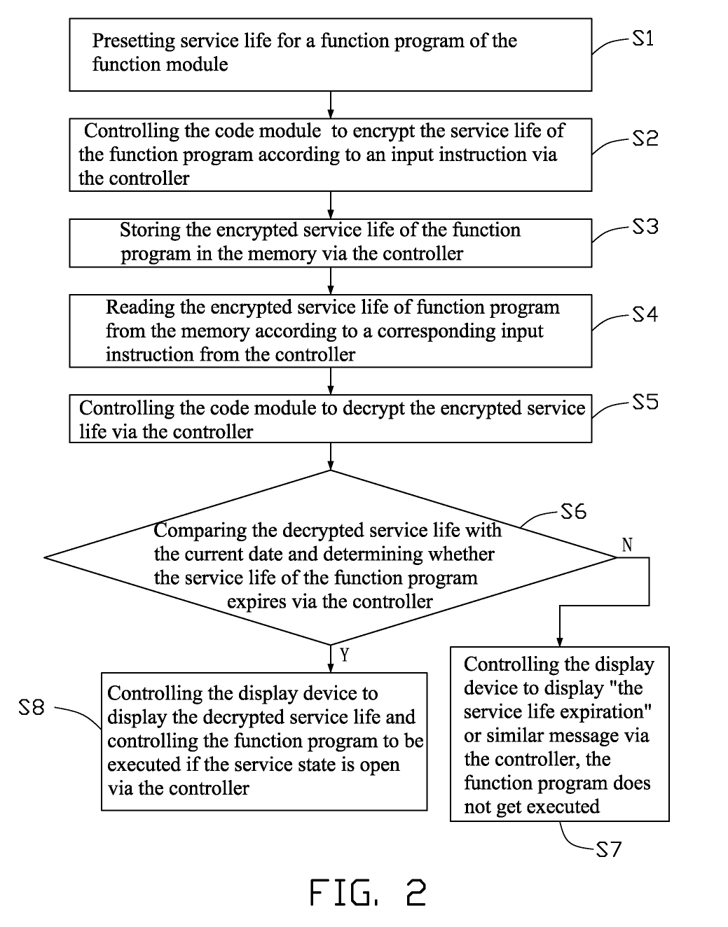

Referring to FIG. 2, an exemplary embodiment of an encrypting method for a CNC device includes the following steps.

Step S1: presetting service life for a function program of the function module 130.

Step S2: controlling the code module 120 to encrypt the service life of the function program according to an input instruction via the controller 110.

Step S3: storing the encrypted service life of the function program in the memory 140 via the controller 110.

Step S4: reading the encrypted service life of function program from the memory 140 according to a corresponding input instruction from the controller 110.

Step S5: controlling the code module 120 to decrypt the encrypted service life via the controller 110.

Step S6: comparing the decrypted service life with the current date and determining whether the service life of the function program expires via the controller 110.

Step S7: If the service life has expired, controlling the display device 150 to display “the service life expiration” or similar message via the controller 110, the function program does not get executed.

Step S8: If the service life has not expired, controlling the display device 150 to display the decrypted service life and controlling the function program to be executed if the service state is open via the controller 110.

The encrypting system and method encrypt the service lives of the plurality of function programs for protecting the function programs from unauthorized uses. During using the function program, the function program is executed after the encrypted service life of the function program is decrypted through an input instruction. When the user wants to buy the function program, programmers reset the service life of the function program according to the request of the user. When the user does not want to buy the function program, the function program does not get executed after the service life of the function program has expired. The system and method prevents the function program from being copied illegally, and benefits the makers of the function programs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. An encrypting system for numerical control devices, comprising:
a function module comprising at least one function program, each of the at least one function program having a preset service life;
a code module configured for encrypting and decrypting the service life of each of the at least one function program;
a memory configured for storing the service life of each of the at least one function program encrypted by the code module;
a controller, wherein when a function program of the function module is needed, the controller reads the corresponding encrypted service life from the memory according to an input instruction and controls the code module to decrypt the encrypted service life, and compares the decrypted service life with the current date to control the function program to be executed in response to the service life of the function program being later the current date.

2. The encrypting system of claim 1, further comprising a display device, wherein the display device is configured for displaying the service life decrypted by the code module and related messages.

3. The encrypting system of claim 1, wherein each of the at least one function program further has a preset service state, the service state is an open state presenting that the corresponding function program can be executed, or a close state presenting that the corresponding function program cannot be executed; the controller controls the service state of the function program to control the function program to be executed when the service life of the function program is later than the current date.

4. The encrypting system of claim 1, wherein the code module encrypts and decrypts the service life of each of the at least one function program by Rijindael algorithm.

5. The encrypting system of claim 1, wherein the memory is an electrically erasable programmable read only memory.

6. An encrypting method for encrypting a function program of a numerical control device, the encrypting method comprising:
presetting service life of the function program and encrypting the service life of the function program via a code module;
storing encrypted service life of the function program in a memory via a controller;
reading the encrypted service life of the function program from the memory according to a corresponding input instruction from the controller, and decrypting the encrypted service life via the code module;
comparing the decrypted service life of the function program with the current date and determining whether the service life of the function program has expired via the controller; and
if the service life has expired, not executing the function program; or
if the service life has not expired, executing the function program.

7. The encrypting method of claim 6, further comprising displaying a service life expiration message via a display device in response to the service life of the function program being earlier than the current date, and displaying the decrypted service life of the function program via the display device in response to the service life of the function program being later than the current date.

8. The encrypting method of claim 6, wherein the function program has a preset service state, the service state is an open state presenting that the function program can be executed or a close state presenting that the function program cannot be executed, the method further comprises a step of checking the service state to determine whether the function program should be executed or not.

9. The encrypting method of claim 6, wherein the code module encrypts and decrypts the service life of the function program by Rijindael algorithm.

10. The encrypting method of claim 6, wherein the memory is an electrically erasable programmable read only memory.
